(19) United States
(12) Patent Application Publication
(10) Pub. No.: US 2024/0246264 A1
(43) Pub. Date: Jul. 25, 2024

(54) SUBSTRATE BAND FOR CABLE-WRAPPING TAPE

(71) Applicants: Timo LEERMANN, Wuppertal (DE); Rene RAMBUSCH, Wuppertal (DE)

(72) Inventors: Timo LEERMANN, Wuppertal (DE); Rene RAMBUSCH, Wuppertal (DE)

(21) Appl. No.: 18/414,560

(22) Filed: Jan. 17, 2024

(30) Foreign Application Priority Data
Jan. 19, 2023 (EP) 23152494.3

(51) Int. Cl. B29B 17/04; B29B 7/00; B29B 17/00; C09J 7/22

(52) U.S. Cl. CPC B29B 17/0412; B29B 7/002; C09J 7/22; B29B 2017/0089; B29B 2017/0496; C09J 2203/302

(57) ABSTRACT

A method of making a textile substrate web for use as a component of an adhesive tape has the steps of thermochemically converting plastic waste into raw material, making plastic fibers and/or filaments at least partially from the raw material, and forming the plastic fibers and/or filaments made from the raw material into a textile web.

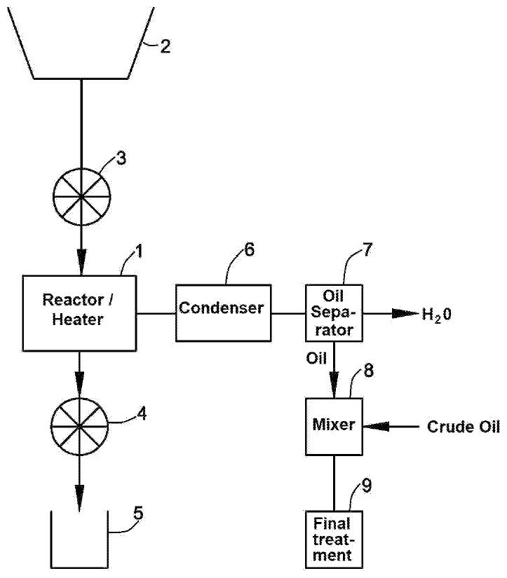

### FIELD OF THE INVENTION

The present invention relates to a substrate band for a cable-wrapping tape and to a method of and apparatus for making this band.

### BACKGROUND OF THE INVENTION

Such a textile web is typically from plastic fibers and/or plastic filaments as a substrate band of an adhesive tape from the plastic fibers and/or filaments that are at least partially made from raw materials from the processing of plastic waste.

An adhesive tape and in particular wrapping tape for cables in automobiles is known from DE 20 2021 106 836 of applicant. The plastic fibers and/or filaments used for this purpose are made at least partly from a plastic recyclate obtained from the processing of hollow plastic bodies. The hollow plastic bodies are in particular PET (polyethylene terephthalate) bottles. The recycled plastic fibers and/or plastic filaments are essentially so-called flakes coming from the processing of PET bottles. The flakes are melted and extruded into fibers or filaments or individual filaments. They can also be made using recourse to new (virgin) materials.

In a similar adhesive tape according to of DE 20 2019 100 588 [US 2021/0371708] of applicant, the textile substrate web is made at least partly with recourse to biobased polymers. For this purpose is made from biobased polymer fibers and/or polymer filaments. These can be made by extrusion. The biobased polymers originate in turn from renewable raw materials made from plant-based materials. For example, plants or also lactic acid can be used.

The state of the art technology has proven itself in principle, as far as resource-conserving production of adhesive tapes and in particular their textile substrate web is concerned. This is because biobased polymers are made using renewable raw materials, whereas the plastic fibers and or filaments according to DE 20 2021 106 836 are made using recycled processed plastic waste in particular from the processing of PET bottles. This presupposes however, that the PET bottles in question are not mixed with other plastics, as is the case with for example mixed plastic waste.

If a mixture of plastics is present, complex separation processes are usually required, achieving purity only in special cases.

Plants for making the textile substrate web for the adhesive tape according to the invention have been known for a long time in principle for example for processing automobile tires and extracting gaseous and liquid hydrocarbons, for which reference is made to DE 24 62 495. The further prior art here is the technology according to the DE 10 2007 056 907 that deals with a plant and a method for thermal treatment of waste materials.

Hence in the generic state of the art so-called material recycling is carried out and special used plastics are processed into new plastic raw materials, so-called regranulate. The flakes made in this way are then further processed into the recycled plastic fibers or filaments. The chemical structure of the material remains practically unchanged.

It is true that such mixed waste can in principle be recycled without separation into individual plastic components. However, the previous procedures for recycling mostly aim essentially at the energy content of the mixed-material waste for energy generation and in particular for generating electricity. This is problematic because CO² is generated and one generally strives to reduce CO² emissions. Here the invention aims to provide a remedy.

### OBJECTS OF THE INVENTION

It is therefore an object of the present invention to provide an improved method of making a nonwoven tape substrate band.

Another object is the provision of such an improved method of making a nonwoven tape substrate band that overcomes the above-given disadvantages, in particular that further develops such a method and an associated apparatus such that, in principle, mixed plastic waste or even other organic waste can also be used.

### SUMMARY OF THE INVENTION

A method of making a textile substrate web for use as a component of an adhesive tape. The method has according to the invention the steps of thermochemically converting plastic waste into raw material, making plastic fibers and/or filaments at least partially from the raw material, and forming the plastic fibers and/or filaments made from the raw material into a textile web.

Thus, in order to attain this object, the invention proposes a generic method for making a textile substrate web where the raw materials are obtained by thermochemical conversion of the plastic waste.

In other words, according to the invention, the adhesive tape and, in particular, the textile substrate web of the adhesive tape made from the plastic fibers and or filaments is still and unchanged at least partially made from raw materials resulting from the processing of plastic waste. For this purpose, the plastic waste is subjected to thermochemical conversion in accordance with the invention.

In contrast to the previous and generic state of the art according to DE 20 2021 106 836, the thermochemical conversion of generally organic waste materials or plastic waste described above takes place first. As a result, the raw material obtained according to the invention is not a regranulate in the above sense, but the raw material has been obtained completely from plastic waste that is largely broken down into its monomers for this purpose and consequently is not a regranulate in the above sense.

This eliminates the need for specific and separate recycling of PET bottles as in the prior art whereby they are mechanically processed by for example shredding into flakes or regranulate, these flakes then in turn being extruded as plastic fibers or filaments. Rather the invention proceeds in such a way that generally practically any organic waste or plastic waste materials are thermally or chemically processed. The thermal chemical conversion takes place thereby largely under exclusion of oxygen, in order to avoid explosions or combustion. In most cases the thermochemical conversion is pyrolysis, thus a decomposition process at high temperatures and with extensive exclusion of oxygen that serves to break down the chemical bonds in the organic or plastic waste. The lack of oxygen in this process thereby prevents combustion.

Thermochemical conversion/pyrolysis of the organic waste materials or the pyrolysis produces or outputs gaseous, liquid and solid products. In accordance with the invention the process functions in that the product mixture obtained during the pyrolysis has a predominantly liquid fraction, namely pyrolysis oil. The is the general case with a so-called fast pyrolysis at temperatures of around the 500 EC with a short retention time of the organic waste materials or plastic waste of less than 10 seconds in a reactor. Because this way the proportion of obtained pyrolysis oil is particularly high with respect to the mass of the inputted organic waste materials or plastic waste, generally more than 50% and mostly even more than 60% and in particular even 70% and more.

In principle the thermochemical conversion of the organic waste materials or plastic waste is generally carried out at temperatures in the range from about 300 EC to about 700 EC. In this method usually a reactor is used to which the organic waste materials or plastic waste is conveyed via so-called rotary valves and from which via such rotary valves also serve for the removal of the treated waste materials. Such rotary valves ensure an almost complete sealing against the atmosphere, so that oxygen cannot get into the reactor from outside. This allows one to exclude any explosion hazard and also avoids a harmful combustion process.

The primary pyrolysis oil obtained in this way from the waste materials or plastics is now used in accordance with the invention to make plastic fibers and/or filaments. For this purpose for example the pyrolysis oil can be used together with fossil oil under application of the so-called mass-balance principle to make the plastic fibers and/or filaments. In this context the pyrolysis oil as well as fossil oil is typically first distilled, then heated and split (“cracked”) and finally processed into pellets or granulate. This is followed by a reaction step such as for example polymerization, polycondensation or also polyaddition. The pyrolysis oil can in principle be processed like fossil oil, so that the finished product is a granulate of the plastic that is in turn melted and extruded according to known processes to form the plastic fibers or plastic filaments that can be made into the textile substrate web.

In this context the pyrolysis oil with a mass fraction of up to 100% can be used. Thus the pyrolysis oil can be practically completely distilled, cracked and subject to subsequently polymerization, polycondensation or polyaddition to form the plastic granulate that then in turn serves the basis of making the plastic fibers or filaments that in turn are used to make the textile substrate web of the adhesive tape according to the invention. The above-mentioned mass-balance principle ensures that the raw material for making the plastic fibers and or filaments of the textile substrate web of the adhesive tape according to the invention can in principle both be the pyrolysis oil and also fossil oil, while the product quality and properties of the thus made plastic fibers or filaments remain the same. The larger the proportion of pyrolysis oil (up to 100%), the more the environmental balance improves while decreasing the so-called CO² footprint of the manufactured product. This applies in particular to the possible case where one works solely with pyrolysis oil for making the plastic fibers or filaments for the textile substrate web of the adhesive tape according to the invention.

In other words, when the pyrolysis oil is admixed with the fossil oil in a proportion of up to 100 wt. % by mass within the scope of the applicable claim 6, the result is that the pyrolysis oil replaces the fossil oil in whole or in part as a raw material for making the plastic fibers and/or filaments. In fact, a proportion of 100% by mass of pyrolysis oil corresponds to the fact that the plastic fibers and/or filaments in question are made entirely from the pyrolysis oil and that no additional admixture of fossil oil is required in this process.

The plastic waste used for making the plastic fibers and or filaments can thereby according to the invention be obtained from the processing of used tires and/or mixed plastic waste. In this context it is conceivable that the plastic fibers and or filaments are generally made from reprocessed plastic that is mainly pyrolysis oil from used tires. In this case the plastic in question can be for example a compound and in particular PA (polyamide). In principle, also other plastics such as for example PET (polyethylene terephthalate) can be made in this way from the pyrolysis oil of used tires. Instead of used tires, of course one can also use other organic plastic waste materials such as the previously already mentioned mixed waste. The decisive factor is the fact that pyrolysis oil is obtained by the thermochemical conversion of the plastic waste and/or used tires, and is then further processed in a conventional manufacturing process, possibly together with fossil oil, to form a plastic granulate that in turn is used to make plastic fibers and/or filaments.

In addition, the invention makes it possible to make the plastic fibers and or filaments from the raw materials from the processing of plastic waste together with biobased polymer fibers and/or polymer filaments to then make the textile substrate web of the adhesive tape. This ensures a particularly resource-saving manufacturing process. In any case, the adhesive tape according to the invention has comparable properties to adhesive tapes in which the plastic fibers or plastic filaments in question were made exclusively using petroleum-based materials. This applies both to temperature resistance and to mechanical properties.

In fact the adhesive tape according to the invention usually has a temperature resistance at least of the temperature class T2 according to LV 312 (10/2009). In this context the temperature class T2 is generally used so that the sheathed cables and their use as cable insulation in combination with the increased temperature of 105 EC remains without embrittlement for as long as 3000 hours. In principle, however, temperature class T3 can also be achieved, which then corresponds to an increased temperature of 125 EC without embrittlement over a time of at least 3000 hours. Reference is made to EP 2 522 705 for an example and explanation.

In addition, the adhesive tape according to the invention has mechanical properties that vary merely and at most 20%, even by at most 10% from the properties of adhesive tapes whose plastic fibers or filaments are entirely made from new material or petroleum-based with otherwise the same textile structure.

With the mechanical properties previously addressed and the abrasion resistance and the associated abrasion classes are according to the previously already mentioned standard LV 312 (10/2009). For this purpose reference is made to the DE 20 2014 011 328. The above-mentioned deviation from a maximum 20% and preferably 10% of the same structure means that for example the abrasion class for the adhesive tape made from petroleum-based plastic predominantly is maintained or at worse reduced to an abrasion class for the adhesive tape according to the invention with the plastic fibers or plastic fibers filaments on the basis of pyrolysis oil of the same structure. In addition, such maximum deviations with regard for example to the stretch-to-break or tear strength and air permeability can be observed, as seem generally in the generic state of the art according to DE 20 2021 106 836.

The textile substrate web made of the plastic fibers or filaments made from raw materials from the processing of plastic waste is advantageously a nonwoven, a woven fabric, a knitted web individually or a combination thereof. In other words, the textile substrate web can be single-layer or multilayer. In the latter case it is conceivable that for example a nonwoven backing is combined with a fabric backing. In principle, the textile substrate web can also be provided on one or both faces with a plastic coating. In this context for example back-face coatings opposite the adhesive coating have proven to be particularly favorable, in order to avoid any adhesion to itself of the adhesive coating when rolling it up.

Another object of the invention is elongated goods such as in particular a cable set that is wrapped with the adhesive tape in question. Here the adhesive tape can be wrapped around the goods or the cable set to run longitudinally to wrap the elongated goods. It is also conceivable and is comprised by the invention that the adhesive tape is helically or spirally wrapped around the cables of the cable set.

Another object of the invention is an apparatus for making a textile substrate web. This apparatus is particularly suitable for carrying out the method described above. Furthermore, the also protected adhesive tape is available at the output side of the apparatus.

### BRIEF DESCRIPTION OF THE DRAWING

The above and other objects, features, and advantages will become more readily apparent from the following description, reference being made to the accompanying drawing shows sole FIGURE is a schematic view of a system for carrying out the method of this invention.

### SPECIFIC DESCRIPTION OF THE INVENTION

The drawing generally shows a reactor 1 that is used for processing organic waste materials. According to this embodiment this reactor 1 is of the type used for processing tires and mixed plastic waste. For this purpose a supply 2 is provided that feeds this organic waste material to the reactor 1 via a rotary valve 3. Waste material produced in this reactor 1 is then discharged into a further processing or collection container 5 via another cell-type feeder valve 4. The reactor 1 is equipped with an internal heater for the thermochemical conversion or pyrolysis of the waste at for example 300 EC to 800 Ec.

In this way, vapor generated on the output side of the reactor 1 is fed via a condenser 6 to an oil separator 7. In the oil separator 7 the pyrolysis oil condensed can be separated for example from any accumulating water as indicated by an arrow.

As a rule, this part of the apparatus shown is a separate subassembly. This means that the individual apparatus elements are generally not at one location or working simultaneously, but can be operated separately from each other in terms of time and work different schedules.

The pyrolysis oil available on the output side of the oil separator 7 may now be mixed with fossil or crude oil in a chamber 8. This is indicated by the arrow leading into the chamber or mixing chamber 8 and showing the inflow of crude oil. Downstream of this mixing chamber 8 is the actual final step of plastic production 9 that in principle consists of the previously already addressed individual production steps of distillation, cracking, polymerization, polycondensation or polyaddition and finally the production of plastic granulate at the output.

The plastic granulate made this way is then extruded and processed into the recycled plastic fibers or plastic filaments that are then in turn processed in known textile processing processes into, for example, a nonwoven as substrate, a web or also combinations. The textile substrate web made in this way is then equipped in the final production stage 9 with an adhesive coating that is applied to the textile substrate web via a nozzle, for example as hot-melt adhesive material or hot-melt pressure-sensitive adhesive used for wrapping a cable set. In the method the hot-melt adhesive material or hot-melt pressure sensitive adhesive can then be UV-cross-linked.

We claim:

1. A method of making a textile substrate web for use as a component of an adhesive tape, the method comprising the steps of:
thermochemically converting plastic waste into raw material;
making plastic fibers and/or filaments at least partially from the raw material; and
forming the plastic fibers and/or filaments made from the raw material into the textile web.

2. The method according to claim 1, wherein the thermochemical conversion takes place largely in the absence of oxygen.

3. The method according to claim 1, wherein the thermochemical conversion is pyrolysis.

4. The method according to claim 3, wherein the pyrolysis predominantly produces pyrolysis oil as the raw material.

5. The method according to claim 4, further comprising the step of:
mixing the pyrolysis oil with fossil oil using the mass balance principle to make the plastic fibers and or filaments.

6. The method according to claim 5, wherein the pyrolysis oil is mixed with the fossil oil in a proportion of up to 100% by mass.

7. The method according to claim 4, wherein the plastic waste that is thermochemically converted into pyrolysis oil is used tires and/or mixed plastic waste.

8. The method according to claim 1, further comprising the step of:
adding biobased polymer fibers and/or polymer filaments made from raw materials from the processing of plastic waste to the fibers or filaments made from the raw material used for making the textile web.

9. The method according to one of claim 8, further comprising the step of:
coating wherein the textile substrate web in whole or in part with an adhesive.

10. The method according to claim 9, wherein the adhesive is a pressure-sensitive UV-cross linkable hot-melt pressure-sensitive adhesive.

11. The method according to claim 9, wherein the textile web coated with the adhesive is wound helically or as a longitudinal wrap around goods to be sheathed.

12. The method according to claim 11, wherein the goods are cables in automobiles.

13. A system, for making a textile substrate web, the apparatus comprising:
means for thermochemically converting plastic waste into raw material;
means for making the plastic fibers and/or filaments are at least partially from the raw material; and
means for forming the plastic fibers and/or filaments made from the raw material into a textile web.

14. The system according to claim 13, wherein the means for thermochemically converting includes a supply of plastic waste, the means for making include a heated reactor receiving the waste and outputting pyrolysis oil.

15. The system according to claim 14, the system further comprising:
means for mixing the pyrolysis oil with fossil oil.

16. The system according to claim 15, wherein the means for making further includes processing means for converting the mixture of pyrolysis and fossil oils into granulates and feeding same to the means for forming the plastic fibers and/or filaments.

17. The system according to claim 13, further comprising:
final-treatment means for coating the textile web at least partially with an adhesive

18. An adhesive wrapping tape for sheathing cables in automobiles, made by the method according to claim 9 and comprising:
a textile substrate web made from plastic fibers and or filaments made at least partially from a raw material itself made from thermochemically processed plastic waste, and
an adhesive coating applied to one or both faces of the web.

19. The adhesive tape according to claim 12, wherein the filaments are biobased polymer fibers and/or polymer filaments made from raw materials and are formed into a nonwoven, woven, knitted or crocheted textile usable as a wrapping-cable substrate band.

20. Use of the adhesive tape according to claim 12 for wrapping cables and forming a cable set.
